(19) United States
(12) Patent Application Publication
(10) Pub. No.: US 2014/0313580 A1
(43) Pub. Date: Oct. 23, 2014

(54) IMMERSIVE DISPLAY APPARATUS

(71) Applicant: Firsthand Technology Inc., Seattle, WA (US)

(72) Inventors: Ari HOLLANDER, Seattle, WA (US); Howard ROSE, Seattle, WA (US); Joel KOLLIN, Seattle, WA (US)

(73) Assignee: Firsthand Technology Inc., Seattle, WA (US)

(21) Appl. No.: 14/254,512

(22) Filed: Apr. 16, 2014

Related U.S. Application Data
(60) Provisional application No. 61/812,955, filed on Apr. 17, 2013.

(51) Int. Cl. G02B 27/22

(52) U.S. Cl. CPC G02B 27/2235
USPC 359/466

(57) ABSTRACT

In various embodiments, a hand-held, desktop, boom, or mechanical arm-mounted apparatus including wide field-of-view (greater than 60-degrees measured diagonally) collimating optics and using either a stereoscopic or offset biocular assembly to remove parallax due to the position of the display can be configured to augment the display on a computer, laptop, tablet, or other image-generating device for the purposes of enhancing its immersive properties.

### CROSS-REFERENCE TO RELATED APPLICATIONS

This application claims the benefit of priority to Provisional Patent Application No. 61/812,955; filed Apr. 17, 2013 under Attorney Docket No. FIRS-2013004; titled “Immersive Display Apparatus”; and naming inventors Ari HOLLANDER et al. The above-cited application is hereby incorporated by reference, in its entirety, for all purposes.

### FIELD

This disclosure is directed to displays, and more particularly, to wide field-of-view, immersive display apparatuses.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Immersive displays are important to a growing range of media and Virtual Reality (VR) applications. Immersion is both a metaphorical term and a technical one. It evocatively compares a compelling media experience with submersion in a foreign medium like water. As the term is used herein, “immersive” refers to the facility of a display system to create a sense of presence in a user: the sense that rather than merely viewing a scene, the user is present in the scene.

There are perceptual and psychological implications to immersion that have practical applications. Strong immersion has been well established in the research literature as a critical factor for applications such as VR Analgesia and Cybertherapy. However, strong immersion has thus far been unfeasibly expensive and difficult to deliver in commercial systems.

VR Analgesia in particular would benefit from a practical and affordable immersive display. Even though VR analgesia has been shown to reduce severe burn pain by up to 90%, there are no commercially available VR pain control systems for less than $40,000 that provide strong immersion. This is largely due to the expense of wide field-of-view displays.

As implied by the definition above, evoking the feeling of immersion is enhanced by displays that effectively “disappear”, thereby enabling the user to be mentally transported into the virtual experience. Displays that provide a wide field-of-view (FOV) have been shown to be more effective at creating immersive experiences. However, not all techniques for achieving a wide FOV are equally effective.

For example, a wide FOV achieved by sitting very close to a two-dimensional television or computer monitor has been shown to fail to achieve strong immersion. One theory is that, while the scene on the screen may be a distant landscape, your eyes tell you the screen itself is quite close and this takes precedence. The display and its contents are an object in your environment.

By contrast, head-mounted displays with a wide FOV can be immersive because they present separate images of the virtual environment to each eye. This removes the depth cues that tell you the displays are actually tiny and extremely close to your eyes, effectively getting rid of the screen and leaving only the virtual environment.

In cases where wearing a display is not desirable, 3D TVs can be immersive if they are large enough and near enough to provide a wide FOV. This is impractical for a range of important applications (and most 3D screens require you to wear glasses).

In most cases, the FOV of a display should be at least 60° measured diagonally in order to be immersive and preferably more than 80° in order to achieve strong immersion. Other pertinent characteristics include infinity collimation and consistency of other depth cues. Stereoscopy is an important depth cue, but is neither a sufficient nor a necessary characteristic of immersive displays.

Immersive displays are typically head-mounted, and (with one notable exception, the Oculus Rift) they remain expensive and fragile, and require exotic micro-displays and powerful optics that severely limit the overall display quality. All of the currently commercially available head-mounted displays (HMDs) have significant flaws that make them unsuitable for a wide range of applications. These flaws include:
Size: Large 3D TVs or projectors require too much space for most applications, and smaller displays would need to be impractically close. For example, a 30-inch 3D TV would need to be viewed at a distance of less than 18 inches to provide an 80° FOV.
Ergonomics: The commercially available wearable immersive displays are uncomfortable, awkward, and unsuitable for extended use. They are also sometimes so heavy or poorly balanced that they are actively painful to use.
Cost: With the exception of the Oculus Rift, HMDs with a minimum 80° FOV start at $36,000. 60° to 70° FOV displays start at about $12,000.
Resolution: Even at the high end, immersive HMDs are typically 1280×1024 per-eye resolution. There are exotic displays with additional usability issues available starting at $39,000 at higher resolutions. The inexpensive Oculus Rift is 640×800 pixels per eye, which makes it unsuitable for many applications. In addition it uses an aspect ratio that is less than unity, which There are sub-$1000 HMDs with 1920×1080 resolution, but all of the ones on the market are non immersive (<45° FOV).
Reliability: Many commercially available immersive displays (with the possible exception of the Occulus Rift, which has not been available long enough to have relevant data) have issues with reliability. In our experience, many have a 100% failure rate in the first year, and the cost of repairs remains extremely high.

There are situations and applications where wearing a display is undesirable or impossible. Examples include any general application that is of a long duration or specific applications like VR pain control for patients with wounds on the head or face.

Hand-held displays have been shown to effectively create strong immersion and mechanical-arm-mounted displays have been used successfully in VR Analgesia. In spite of the low-quality display characteristics of HMDs, even the arm-mounted VR Analgesia work has been done by taking an HMD and modifying it for arm-mounting. This perpetuates all the quality and cost problems of the HMD domain.

### BRIEF DESCRIPTION OF THE DRAWINGS

FIG. 1 depicts an assembly attached to a laptop mounted on a mechanical arm in accordance with one embodiment.

FIG. 2 depicts a simplified cross-sectional view of the optical components in accordance with one embodiment.

FIG. 3 depicts a simplified representation of an embodiment including periscope mirrors and vertically divided (over-under) image multiplexing in accordance with one embodiment.

FIG. 4 depicts a magnetically mountable lens assembly in accordance with one embodiment.

FIG. 5 depicts the optical plate and sliding magnetic mount system that allows interpupillary distance adjustment in accordance with one embodiment.

FIG. 6 depicts one embodiment with a window for direct screen viewing.

FIG. 7 depicts ocular mirrors with beveled inner edges that may be useful in some embodiments.

FIG. 8 depicts the relationship between the optical path length and mirror angle as described in formula 1.

### DESCRIPTION

In various embodiments, a hand-held, desktop, boom, or mechanical arm-mounted apparatus including wide field-of-view (greater than 60-degrees measured diagonally) collimating optics and using either a stereoscopic or offset biocular assembly to remove parallax due to the position of the display can be configured to augment the display on a computer, laptop, tablet, or other image-generating device for the purposes of enhancing its immersive properties.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined, without limiting the scope to the embodiments disclosed within.

One of ordinary skill in the art will appreciate that many of the figures are not to scale and have components resized, moved and/or removed in order to better illustrate various exemplary embodiments.

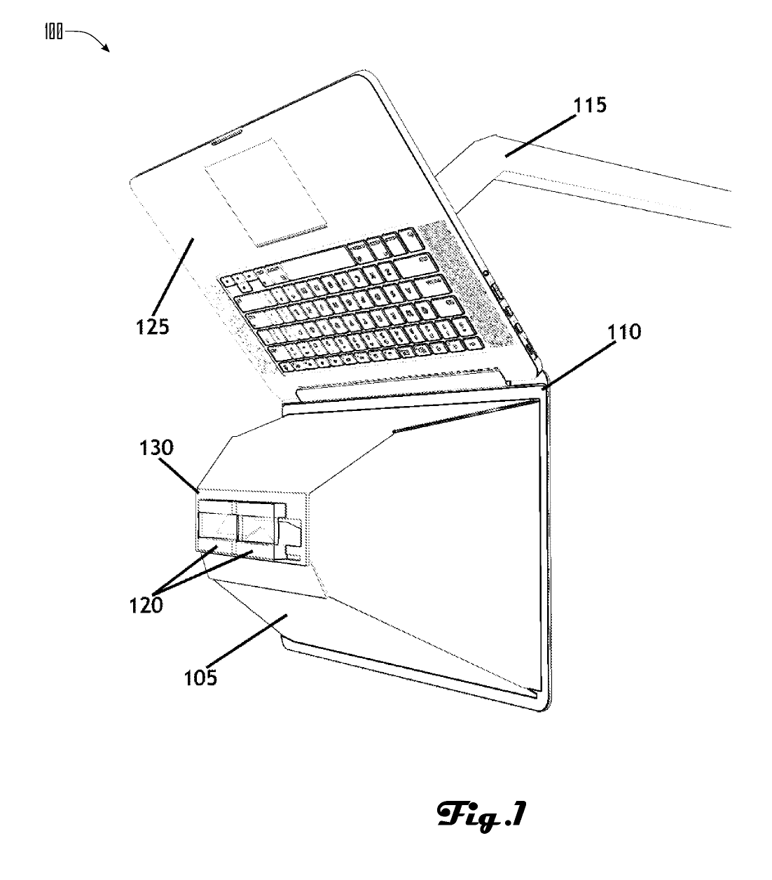

FIG. 1 depicts a simplified representation of a stereoscopic periscope assembly 105 in accordance with one embodiment. Stereoscopic periscope assembly 105 is attached to the display of a laptop computer 125 using a mounting bezel 110. Laptop computer 125 (and by extension, stereoscopic periscope assembly 105) are held by a mechanical arm 115.

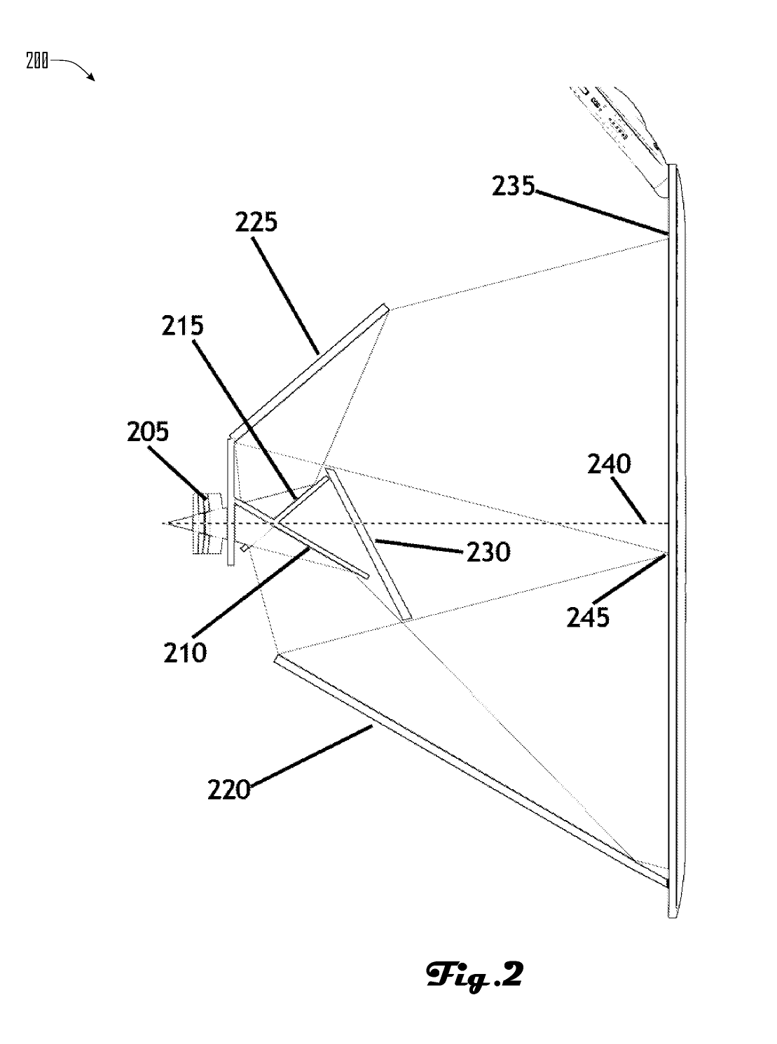

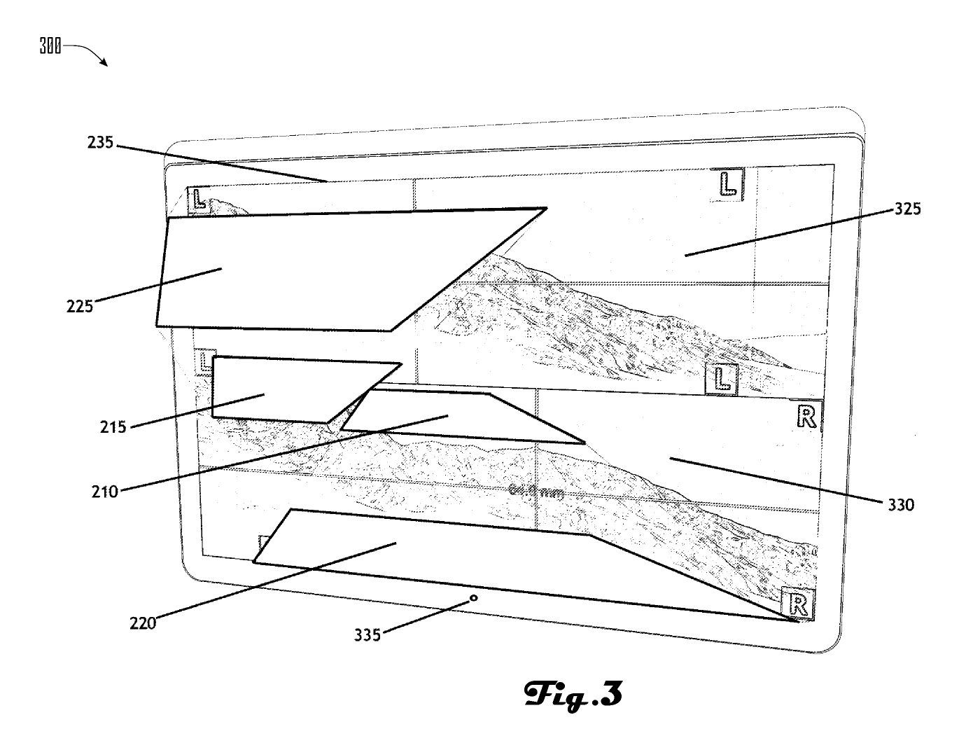

In the illustrated embodiment, separate images rendered for the left and right eyes occupy the upper and lower halves of the screen (which is obscured in FIG. 1 by stereoscopic periscope assembly 105, but see FIG. 3). Periscopes (not shown, but see FIG. 2) displace the optical paths of the eyes vertically to achieve stereopsis. The collimating optics 120 bring each screen image into focus and place them at optical infinity.

In some embodiments, laptop 125 may include a high-pixel-density display, such as that provided by an Apple MacBook Pro with Retina Display, a Google Chromebook Pixel, or the like. Such embodiments can take advantage of the high-resolution displays on these types of devices, and the vertical division of the screen creates a wide aspect ratio of approximately 3:1, which is conducive to immersion.

In the illustrated embodiment, laptop 125 is mounted in an inverted position so as to move the keyboard overhead and away from the user. Other embodiments may mount laptop 125 in a non-inverted position.

FIG. 2 depicts a cross-sectional view that exposes the internal optical components of stereoscopic periscope assembly 105 (see FIG. 1, discussed above). In some embodiments the lenses 205 are aspheric optics with an effective focal length equal to the folded distance from the lens vertex, through reflections off of the two mirrors for each eye, and to the display. These lenses typically have eye relief of between 13.5 mm and 20 mm and in the illustrated embodiment have an effective focal length of about 180 mm.

The left and right ocular mirrors 215 and 210 (also shown in FIG. 3, discussed below) are trapezoidal, shaped to match the perspective-projected size and shape of the respective sub-regions (see sub-regions 325 and 330 of FIG. 3, discussed below) of the screen 235 as viewed from each eye. Ocular mirrors 215 and 210 are parallel to the primary mirrors 220 and 225 (also shown in FIG. 3).

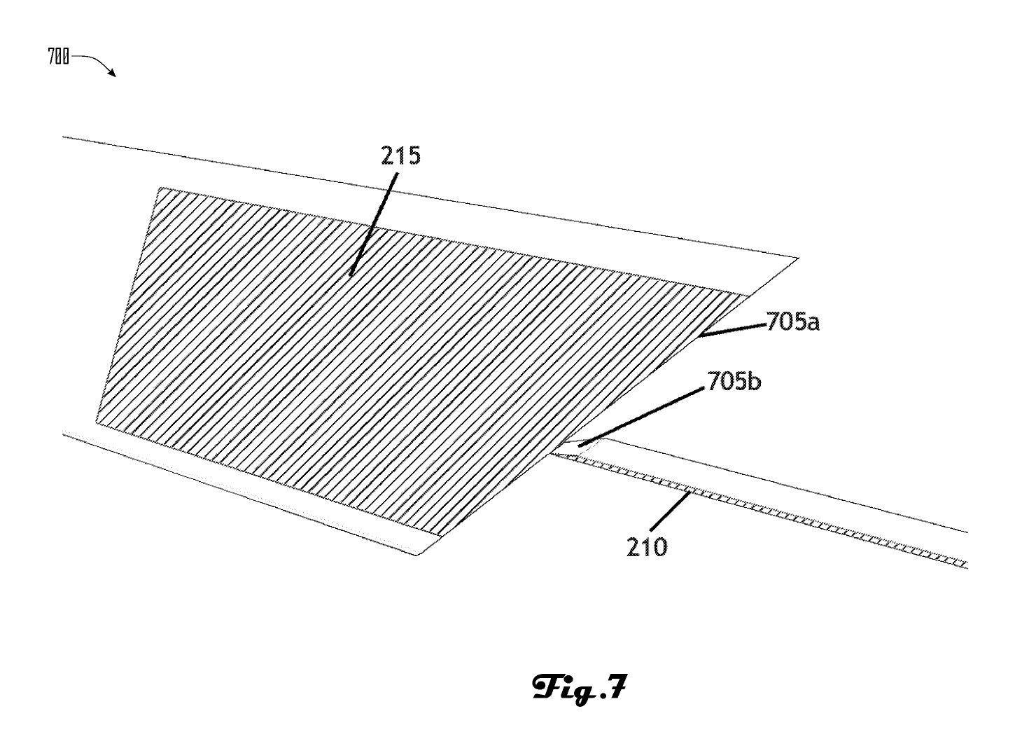

In some embodiments, the convergent FOV (on the nose side of each eye) may be limited by the proximity of the ocular mirrors 305, 310. As illustrated by FIG. 7, in some embodiments, the inner edges 705a-b of the ocular mirrors 305, 310 may be beveled such that the reflective surfaces can be as close together as possible.

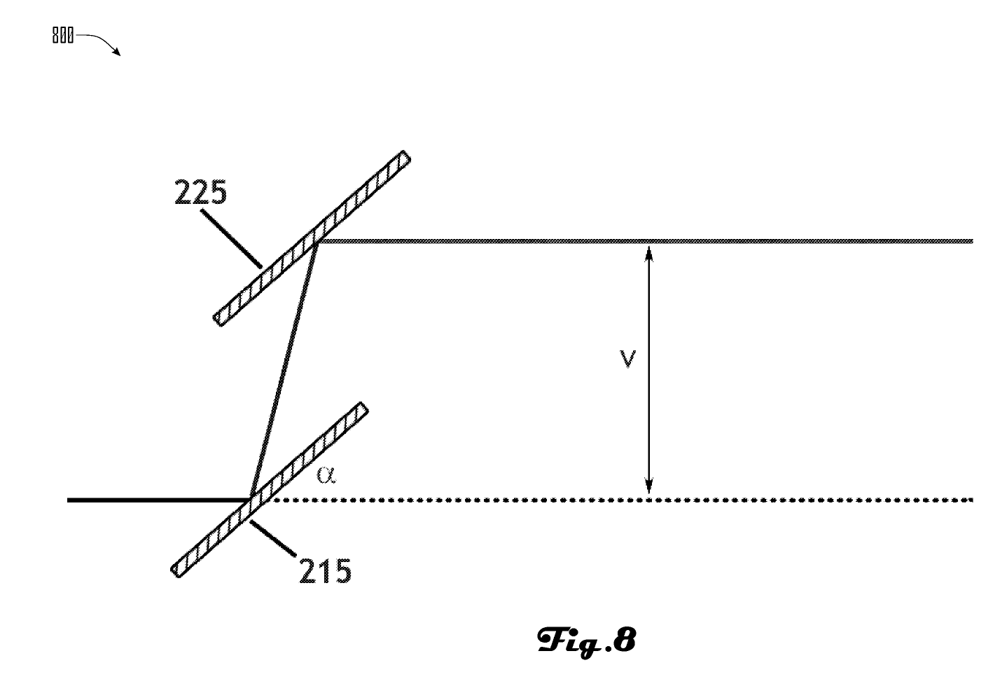

Referring again to FIG. 2, in some embodiments it may be useful to tilt the ocular mirrors 215, 210 at angles other than 45 degrees to change the optical path length and/or have the left and right ocular mirrors 215, 210 at different angles to the optical axis 240. This causes a shift in the optical length between the eyes that can be compensated for by a corresponding shift in the position of the screen 235. The change in path length due to deviations from a 45-degree mirror can be computed with the formula:

$$Δ p = v ( \sqrt{1 + \frac{1}{{tan}^{2} 2 α}} ) - \frac{1}{tan 2 α} - 1 \qquad Formula 1$$

Where Δp is the difference in path length, v is the vertical displacement and α is the mirror angle as shown in FIG. 8. This relationship can be used in various embodiments to modify the geometry as needed.

As illustrated in FIG. 2, the center 245 of the screen falls below the optical axis 240. This shift, coupled to the corresponding changes in the size and positioning of the primary mirrors 220, 225, keeps the reflected images rectangular and may be useful in accommodating the nose of the user. In some embodiments, the entire assembly may be invertible about the screen center 245 in order to accommodate noses of different sizes and shapes.

In some embodiments, masking may be employed to block alternate view paths to the display. In some embodiments, an interstitial mask 230 can be used in combination with the masking provided by the optical plate 130 (see FIG. 1, discussed above) and supplementary masking directly on the lenses (not shown) to block some undesirable views. In some embodiments, a septum mask interposed between the ocular mirrors 210 & 215 may also be used.

FIG. 3 shows a perspective rendering of the screen 235 and the four mirrors 210, 215, 220, and 225 in accordance with one embodiment. The perspective rendering illustrates the vertical arrangement and horizontal shift of left and right eye images 325, 330. In some embodiments, the displayed images may be horizontally shifted in order to be centered on the respective optical axes of each eye. In such embodiments the software rendering may be configured to match the interpupillary distance of the user. In some embodiments, asymmetric view frusta, offset by the interpupillary distance may be used to achieve correct perspective.

Some laptops have a camera 335 embedded in the top (or in the inverted case, the bottom) of the display 235. In some embodiments, it may be useful to expand the vertical extent of the mirrors 210 and 220 so that it is possible to use camera 335 to measure the pupil offset and automatically adjust the rendering. In some embodiments, camera 335 may be used to capture various biometric inputs such as pupil dilation, blink sensing, eye tracking, and the like.

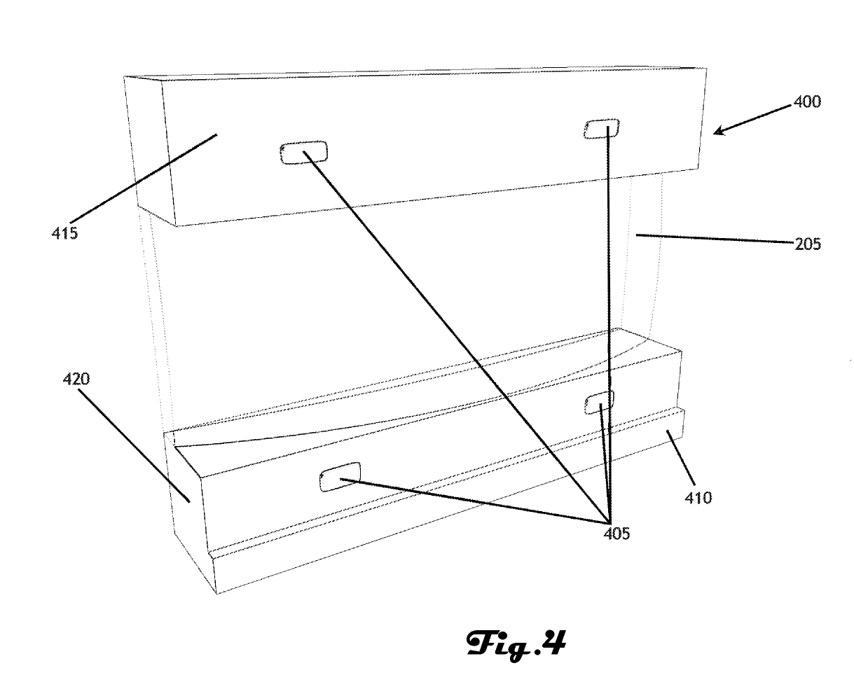

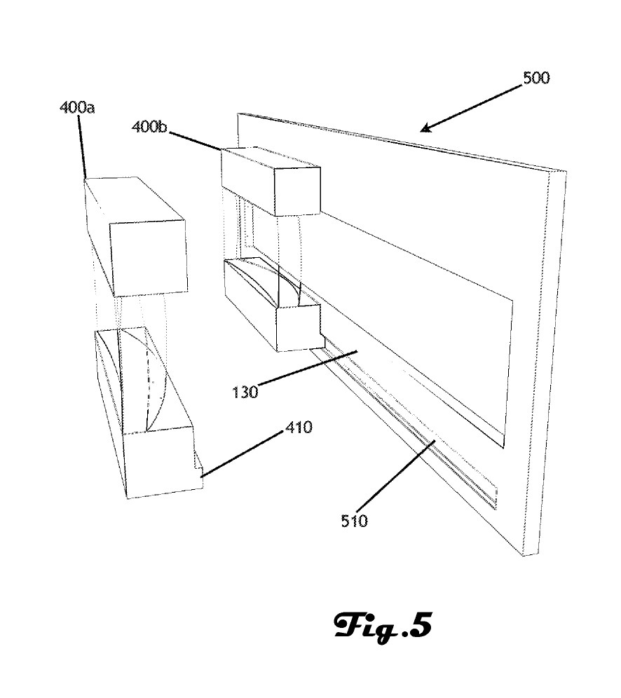

FIGS. 4 and 5 depict a magnetic lens mount 400 and adjustment system 500 that may be used in some embodiments to mount lenses 205 to stereoscopic periscope assembly 105. In these situations, the upper and lower lens mounts 415, 420 are affixed to each lens 205. The lens mounts 415 and 420 have one or more powerful permanent magnets 405 attached to or embedded in the mount. The adjustment flange 410 and the interpupillary adjustment groove 510 may be used to appropriately align the lenses for different users.

In some embodiments, the optical plate 130 may be composed in whole or in part of ferromagnetic material, allowing the magnet lens mounts 400 to adhere, be slid along the groove 510 to accommodate different interpupillary distances, and be easily exchanged for lenses of different properties to accommodate users with various eyeglasses prescriptions. In some embodiments, optical plate 130 may be covered with plastic wrap or the like (for the purposes of hygiene and sterilization) before magnetically attaching the lenses.

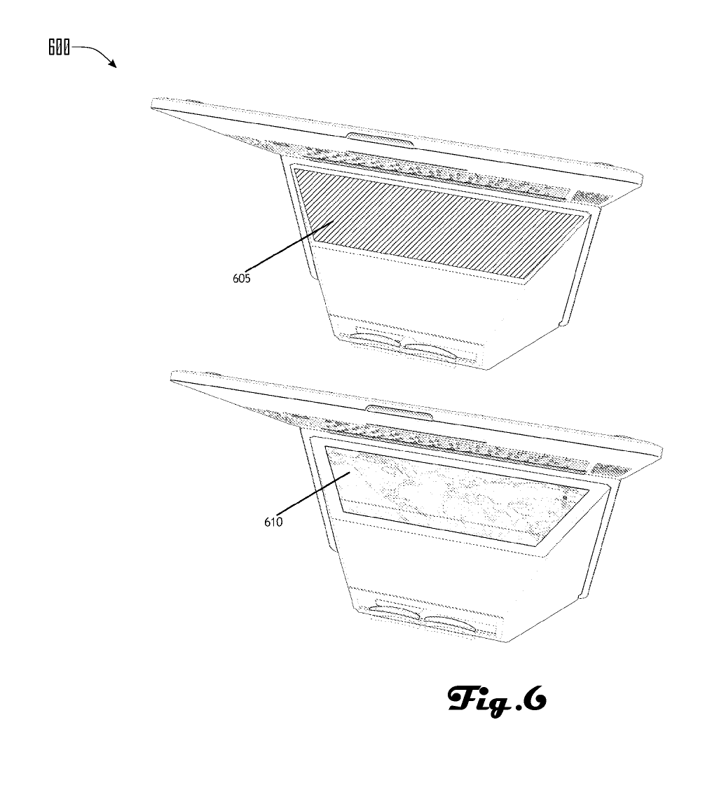

In some embodiments, the stereoscopic periscope assembly 105 as variously illustrated may be configured to be openable and/or removable so that the laptop 125 can be used normally. FIG. 6 illustrates an alternative for embodiments where it is desirable for the assembly to remain attached and/or sealed. A hinged or removable panel 605 covers a transparent window 610 that allows an unobstructed view of the entire screen.

Alternate embodiments may use other stereoscopic image multiplexing layouts or methods including but not limited to temporal multiplexing with shutters, polarization multiplexing, lenticular or parallax-barrier multiplexing, or the like. Many of these require alternate display devices compatible with these techniques, for example high frame-rate displays may be desirable for temporal multiplexing in order to avoid flicker.

One embodiment may attach to a tablet, possibly having a high-pixel-density, instead of a laptop computer. Such an embodiment may be hand-held rather than mounted. Examples of appropriate tablet devices might include the Apple iPad with retina display, the Google Nexus 10, or the like. In such embodiments, a touch-sensitive input may be positioned on the back of the tablet to compensate for the occlusion of the touch screen.

A variation on many of these embodiments employs a biocular rather than binocular configuration, displaying the same image to each eye. By presenting an identical collimated image to each eye—or images that are identical other than their cropping—it is possible to produce an ecologically correct rendition of a scene that appears as if it were large viewed from a great distance, perhaps though a window. This variation takes advantage of the full resolution and extent of the display for each eye, effectively doubling both the FOV and the resolution seen by the viewer while reducing the computational rendering requirements by almost half. This may be accomplished by using an optical device such as a grating or prism to offset the image for each eye, using periscope optics, putting a ‘slab-off’ prism in the ophthalmic optics used to collimate the image, or by other means known to those skilled in the art.

We claim:

1. A wide field-of-view, immersive display apparatus, as shown and described.
